(19) United States
(12) Patent Application Publication
(10) Pub. No.: US 2009/0014094 A1
(43) Pub. Date: Jan. 15, 2009

(54) Methods for Reducing Hexavalent Chromium in Trivalent Chromate Conversion Coatings

(76) Inventors: Joseph Kuezynski, Rochester, MN (US); Kevin A. Splittstoesser, Stewartville, MN (US); Timothy J. Tofil, Rochester, MN (US); Paul A. Vermilyea, Rochester, MN (US)

Correspondence Address: WOOD, HERRON & EVANS, L.L.P. (IBM), 2700 CAREW TOWER, 441 VINE STREET, CINCINNATI, OH, 45202, US

(21) Appl. No.: 11/776,696

(22) Filed: Jul. 12, 2007

(51) Int. Cl. B32B 15/00; C23C 22/05; C23C 22/82

(52) U.S. Cl. 148/265; 148/267; 148/400

(57) ABSTRACT

The present invention is directed to trivalent chromate conversion coatings for plated metals, and more particularly, to methods for reducing hexavalent chromium in trivalent chromate conversion coatings. In one embodiment, such method includes placing a metal article having a trivalent chromate conversion coating in a reducing solution. The trivalent chromate conversion coating includes hexavalent chromium and the reducing solution including a reducing agent, which reduces the hexavalent chromium so as to reduce or eliminate the hexavalent chromium on the plated metal article.

### FIELD OF THE INVENTION

The present invention is directed to trivalent chromate conversion coatings for plated metals, and more particularly, to methods for reducing hexavalent chromium in trivalent chromate conversion coatings.

### BACKGROUND OF THE INVENTION

In the metal finishing industry, a zinc coating, for example, may be used to provide corrosion protection to metal articles, e.g., steel fasteners, sheet metal, castings, etc. The zinc coating, whether deposited as an electroplated or hot dip galvanized coating, in turn typically requires a chemical passivation treatment for additional corrosion protection. To that end, a chromate conversion coating may be applied to passivate zinc, or other metals such as cadmium, copper, silver, magnesium, tin and their alloys, for example, to slow corrosion of the metal article. Such conversion coating may also provide metal surfaces with improved adhesion for additional coatings such as paint or other finishes.

Widely used chromate conversion coatings use hexavalent chromium. Although conversion-coating techniques using hexavalent chromium provide satisfactory results, hexavalent chromium can be toxic and is recognized as a human carcinogen. Hexavalent chromium baths used for passivation require special treatment such as prior to disposal, with the waste from a hexavalent chromium based solution creating significant environmental concerns. Accordingly, hexavalent chromium can be harmful to both people and the environment.

For health and environmental considerations and to comply, for example, with hexavalent chromium restriction legislation, such as the Restriction of Hazardous Substances Directive (RoHS) that was adopted in February 2003 by the European Union, the industry is developing safer, less toxic alternatives. One alternative to hexavalent chromium is a trivalent chromate conversion coating which is less environmentally damaging. However, during passivation of metal articles with trivalent chromate conversion coatings, the possibility exists for cross-contamination with hexavalent chromium and/or interconversion of trivalent chromium, such as by air oxidation of residual trivalent chromium. As such, the presence of toxic hexavalent chromium still may persist despite the alternate use of trivalent chromium in chromate conversion coating processes.

It would thus be desirable to provide a method for reducing the hexavalent chromium in trivalent chromate conversion coatings to reduce or eliminate the hexavalent chromium on the plated metal article.

### SUMMARY OF THE INVENTION

In accordance with an embodiment of the present invention, a method for reducing hexavalent chromium in a trivalent chromate conversion coating is provided. Such method includes placing a metal article having a trivalent chromate conversion coating in a reducing solution. The trivalent chromate conversion coating includes hexavalent chromium and the reducing solution including a reducing agent, which reduces the hexavalent chromium so as to reduce or eliminate the hexavalent chromium on the plated metal article.

In another embodiment, the method includes immersing a metal article in a trivalent chromium solution to apply a trivalent chromate conversion coating to the metal article. The metal article is removed from the trivalent chromium solution. Such metal article, which includes the trivalent chromate conversion coating, is placed in a reducing solution. That trivalent chromate conversion coating includes hexavalent chromium and the reducing solution includes a reducing agent. The hexavalent chromium is reduced in the reducing solution to trivalent chromium by reacting the hexavalent chromium with the reducing agent.

In yet another embodiment, the method for reducing hexavalent chromium in a trivalent chromate conversion coating includes applying a trivalent chromate conversion coating to a metal article. Next, the metal article, with its trivalent chromate conversion coating, is placed in a first reducing solution. The trivalent chromate conversion coating has hexavalent chromium and the first reducing solution includes a first reducing agent, which reduces the hexavalent chromium. The metal article then is dried and placed in a second reducing solution. That metal article includes the trivalent chromate conversion coating including additional hexavalent chromium and the second reducing solution includes a second reducing agent, which reduces the additional hexavalent chromium.

In one example, the reducing agent reduces the hexavalent chromium to trivalent chromium. In another example, the reducing agent reduces the hexavalent chromium so that less than 1000 ppb of hexavalent chromium remain on the plated metal article. In another example, the reducing agent reduces the hexavalent chromium so that trace levels to no hexavalent chromium remains on the plated metal article, i.e., in the trivalent chromate conversion coating. Trace levels may be generally defined as less than or equal to about 20 ppb hexavalent chromium.

By virtue of the foregoing, methods are provided for reducing hexavalent chromium in trivalent chromate conversion coatings to reduce or eliminate the hexavalent chromium on the plated metal article.

### DETAILED DESCRIPTION

In accordance with an embodiment of the invention, a method is provided for reducing hexavalent chromium in trivalent chromate conversion coatings to reduce or eliminate the hexavalent chromium on the plated metal article. Such trivalent chromate conversion coatings are plated on metal articles via trivalent chromate conversion coating processes. The method for reducing hexavalent chromium generally involves placing the metal article having the trivalent chromate conversion coating in a reducing solution. The trivalent chromate conversion coating includes hexavalent chromium and the reducing solution includes a reducing agent, which reduces the hexavalent chromium. That general method, along with trivalent chromate conversion coating processes, is further described in detail below.

To that end, prior to the placing of a metal article in a reducing solution, a trivalent chromate conversion coating generally is applied to the metal article (e.g., a steel article) using, for example, a batch process having a sequential series of process tanks. In that process, the metal article is typically cleaned, rinsed, plated with a metal, such as zinc, for corrosion protection, then immersed in a trivalent chromium plating bath to apply the trivalent chromate conversion coating for additional corrosion protection. After which time, the metal article is typically finally rinsed and dried. Then the trivalent chromium conversion coated, zinc-plated steel article is subjected to a reducing solution to reduce or eliminate hexavalent chromium in the trivalent chromium conversion coating.

With respect to the cleaning process, the metal article, such as an iron-containing alloy (e.g., steel), which will receive the trivalent chromium conversion coating, generally must first be cleaned. Other types of metal instead of steel may be utilized as known in the art. In addition, the metal article can define any variety of metal articles, such as sheet metal panels, metallic fasteners, such as screws, nuts, and bolts, and the like.

Any number of known processes for cleaning the steel article may be utilized. One such process is solvent vapor degreasing, which is disclosed in Milacron Marketing Co. Technical Report No. J/N 96/43 (3/99), entitled “Guidelines for Cleaning Stamped Metal Parts,” which is expressly incorporated by reference herein in its entirety. Such solvent vapor degreasing includes exposing the metal article to a 1,1,1-trichloroethane vapor for about 2 min at room temperature, followed by air dry. Other suitable solvents can include perchloroethylene, trichloroethylene, and methylene chloride as well as non-ozone-depleting solvents known to those having ordinary skill in the art.

Another suitable cleaning process includes an in-line spray or immersion cleaning, which are also disclosed in Milacron Marketing Co. Technical Report No. J/N 96/43 (3/99), entitled “Guidelines for Cleaning Stamped Metal Parts,” which is expressly incorporated by reference herein in its entirety. Such in-line spray or immersion cleaning uses an acidic or alkaline water-based system. Typically, spray and immersion time of the steel article are determined via trial and error. In addition, the temperature of the water-based system generally is about 60-70° C., with lower temperature cleaners being available. Cleaning efficiency tends to approximately double with each 10° C. increase in temperature. The acidic and alkaline concentration of the water-based system is also typically determined via trial and error but is understood to be generally linearly correlated to cleaning efficiency.

After cleaning, the steel article typically is rinsed with deionized or tap water. The rinse generally involves using a series of counter flow rinse tanks and immersing the article in each tank for about 30 seconds at room temperature.

Accordingly, in one embodiment, the cleaning process includes immersing the steel article in Uniclean Soak TS-L (available from Atotech USA, Inc., Rock Hill, S.C.), which is a high-alkalinity immersion cleaner for steel substrates, at 70° C. for 5 minutes. Next, the steel article is immersed in Uniclean Electro XK-L (available from Atotech USA, Inc.), which is a high-alkalinity specialty cleaner designed for removing difficult smuts, at 70° C. for 3 minutes at 4-6 Volts, anodic. Optionally, the steel article may be further immersed in a Uniclean AS-30 acid salts solution at room temperature for 15 seconds. Uniclean AS-30 (available from Atotech USA, Inc.) is a water soluble, dry acid powder that consists of a mixture of acid salts, activators, and surface-active agents. Finally, the steel article is rinsed with tap water using a series of counter flow rinse tanks and immersing the article in each tank for about 30 seconds at room temperature.

Once cleaned and rinsed, the steel article may be electroplated or hot dip galvanized with zinc or alloys thereof, as is known in the art. Other metals such as aluminum, cadmium, copper, silver, magnesium, tin and their alloys, for example, can be utilized instead of zinc and may be used on metal articles other than steel as understood by those having ordinary skill in the art. Plating of the metal article is followed by a water rinse, such as with deionized or tap water. The rinse generally involves using a series of counter flow rinse tanks and immersing the article in each tank for about 30 seconds at room temperature.

In one embodiment, the steel article is zinc plated using Zylite (available from Atotech USA, Inc.), which is a hot-working weak-acidic, ammonium-free zinc electrolyte. The Zylite is mixed with water, e.g., deionized water, in a bath and the steel article is zinc plated by immersion thereof in the Zylite solution (11%-50% by vol) at room temperature for 10 min at 25 amps per square foot. The zinc plated steel article then is removed and rinsed with tap water using a series of counter flow rinse tanks and immersing the steel article in each tank for about 30 seconds at room temperature. Hot dip galvanizing processes or other plating methods may be utilized as understood by one having ordinary skill in the art.

Next, the zinc plated steel article is subjected to a chemical passivation treatment for additional corrosion protection. To that end, the cleaned steel article may be immersed in a bath including a trivalent chromium solution. The trivalent chromium solution typically includes a reducing agent, such as a nitrate, and a source of trivalent chromium to provide the steel article with the trivalent chromate conversion coating. A host of other components may be present in the solution to stabilize the bath, as well as complex unreacted trivalent chromium, etc. The temperature, immersion time, and pH of the solution are controlled as understood by one having ordinary skill in the art. Specific passivation treatments tend to vary from plating vendor to plating vendor. Trivalent chromate conversion coating of the metal article is followed by a water rinse, such as with deionized or tap water. The rinse generally involves using a series of counter flow rinse tanks and immersing the article in each tank for about 30 seconds at room temperature.

One such suitable passivation treatment is disclosed in U.S. Pat. No. 7,029,541 entitled “Trivalent Chromate Conversion Coating”, which is expressly incorporated by reference herein in its entirety. Generally, the trivalent chromium solution includes film forming agents, pH buffers, stabilizers, and polishing agents. For ease of manufacturing, storage, and transportation, the trivalent chromium solution is produced in concentrated form. The concentrate is diluted, such as with water, to produce the trivalent chromium solution of the general composition described in the following table:

| Component | (Moles/L) |
|---|---|
| Chromium (III) | 0.020-0.075 |
| Cobalt (II) | 0.010-0.035 |
| Fluoride | 0.005-0.020 |
| Nitrate | 0.010-0.045 |
| pH | 1.5-3.0 |

The trivalent chromium ions and the divalent cobalt ions may be provided in the form of Cr₂(SO₄)₃ and CoSO₄. Without being bound by theory, it is believed that the sulfate ions function as film formers on the zinc plated surface. The sulfate ions also act as a buffer and control the pH of the solution while enhancing its stability. Nitric acid is used to partially oxidize the zinc surface. However, the nitric acid level employed is generally below a level resulting in oxidation of trivalent chromium to hexavalent chromium. This can be achieved by employing a ratio of nitrate ions (resultant from nitric acid) to the combination of chromium and activator metal ions (e.g., cobalt) of less than 1.5:1. Fluoride can be used to polish the zinc surface. The trivalent chromium ions and the divalent cobalt ions serve to form the conversion coating on the zinc plated surface.

The concentrated form of the trivalent chromium solution is diluted before immersion of the zinc plated steel article. Specifically, a bath of the trivalent chromium solution can be prepared using a clean tank. The tank or the tank lining may be made from a material inert to the trivalent chromium solution, such as polyethylene, polyvinyl chloride (PVC), or stainless steel, for example. Clean, 20° C. to 40° C. water may be added to the tank to greater than about 90% of the tank's working volume, preferably about 95% of the working volume. Then, while mixing, 3.0% to 10% of the working volume of the tank can be filled with the concentrated form of the trivalent chromium solution. Finally, the rest of the working volume of the tank is filled with water. In an embodiment of the invention, the pH of the working bath, i.e., the diluted form of the trivalent chromium solution is in the range of 1.5 to 3.0.

The zinc plated steel article is immersed in the bath at a temperature of about 20° C. to 40° C. for 25-75 seconds. After which time, the steel article is rinsed in water, and may be then rinsed a second time in water at a temperature of 20° C. to 60° C. Following rinsing, the articles are dried.

In another embodiment, the passivation treatment involves immersing, at room temperature for 60 seconds, the zinc plated steel article in a solution of Tridur ZnB or Corrotriblue Extreme (both available from Atotech USA, Inc.) in water, e.g., deionized water, per the manufacturer's recommended concentration. Tridur ZnB and Corrotriblue Extreme are blue trivalent passivates. The resulting solution has a pH of 1.8. After the indicated period, the steel article is removed and rinsed in tap water then dried.

In another embodiment, the passivation treatment involves immersing, at a temperature of 21° C.-29° C. for 30-45 seconds, the zinc plated steel article in a 3-5% solution of Tripass LTC Blue (available from MacDermid Industrial Solutions, Waterbury, Conn.) in water, e.g., deionized water, such solution having a pH of 1.8-2.3. Tripass LTC Blue is a blue bright passivate with neutral salt spray protection (>1000 hrs) and includes a proprietary mixture of trivalent chromium compounds (2-5 wt %) and nitric acid (5-15 wt %), with the remaining balance understood as water. In yet another embodiment, the passivation treatment involves immersing, at a temperature of 60° C.-70° C. for 60-150 seconds, the zinc plated steel article in an 11-16% solution of ELV Tripass 1000 (available from MacDermid Industrial Solutions) in water, e.g., deionized water, such solution having a pH of 1.6-2.0. The ELV Tripass 1000 is an iridescent trivalent passivate for electrodeposited zinc and zinc alloys that produces a polished, light iridescent green-yellow coating with desirable corrosion resistance, and includes 5-10 wt % chromium chloride, 20-30 wt % sodium nitrate, 0.2-1 wt % cobalt chloride, and water. After the indicated period, the steel article is removed and rinsed in tap water then dried. Typically, a plating vendor will confirm that the rinse is adequate by monitoring a final rinse tank for pH and drag out of plating bath salts.

Drying of the steel article, with its trivalent chromium conversion coating, may occur at room temperature and for a sufficient period of time for the conversion coating to dry. As understood by one having ordinary skill in the art, both time and temperature are interdependent, i.e., the warmer the drying air, the shorter the drying time, which is typically verified visually.

With trivalent chromate passivation of the plated metal article, it is possible for the trivalent chromate conversion coating to become cross-contaminated with hexavalent chromium and/or for the trivalent chromium to interconvert, i.e., be oxidized, such as via air oxidation of residual trivalent chromium on the steel article. To remove that hexavalent chromium from the trivalent chromate conversion coating, the steel article, after drying, is placed or immersed in a bath including a reducing solution having a reducing agent, e.g., sodium hydrosulfite, at a concentration of about 5-50 g/L water. In another embodiment, the reducing agent is at a concentration of about 10-40 g/L. In yet another embodiment, the reducing agent is at a concentration of about 15-20 g/L.

The steel article with its hexavalent chromium is placed into the reducing solution for an interval independently determined to reduce the hexavalent chromium. In one embodiment, the steel article is immersed for 5-60 minutes at a temperature of 25° C.-90° C. The reducing agent reacts with the hexavalent chromium to reduce or eliminate the hexavalent chromium on the zinc plated steel article, i.e., in the trivalent chromate conversion coating, to trivalent chromium, for example. In one embodiment, the reducing agent reduces the hexavalent chromium so that less than 1000 ppb of hexavalent chromium remains on the plated metal article. In another embodiment, the reducing agent reduces the hexavalent chromium so that trace to no hexavalent chromium remains on the plated metal article. Activity of the reducing agent is understood to increase with increasing temperature. In addition, as both the temperature and concentration of the reducing agent increases, immersion time can decrease.

Along with sodium hydrosulfite, other suitable reducing agents include, for example, sulfur dioxide (Cr₂O₇²⁻+3SO₂+2H⁺===>2Cr³⁺+3SO₄²⁻+H₂O), sulfurous acid, ascorbic acid, lithium borohydride (LiBH₄) in tetrahydrofuran (THF), trialkyl borohydride salts in THF, sodium sulfite, thiosulfates, ferrous sulfate and other metal sulfates (provided that the metal ion is incapable of oxidizing trivalent chromium), mixtures thereof, and the like.

Concerning the selection of the reducing agent, theoretically, it is thermodynamically feasible to reduce hexavalent chromium, Cr(VII), to trivalent chromium, Cr(III), using an agent with a standard electrode potential, E⁰, less than −0.11 V (the potential for reduction of Cr(VII) to Cr(III) in basic solution). However, in acidic conditions, E⁰=1.38 V for the reduction of Cr(VI) to Cr(III), indicating that any reagent with E⁰ less than 1.38V would be suitable. Therefore, the selection of the reducing agent will be dependent upon the pH of the interfacial layer, which is unknown. Consequently, the choice of the reducing agent is relegated to trial and error. For example, vanadium salts could be utilized in basic solution since E⁰=−0.26 V for V³⁺+e⁻===>V²⁺ in aqueous media. The choice of the reducing agent will depend upon the pH of the bath and the nature of the redox reaction. For example, it is thermodynamically feasible to utilize aqueous nickel salts to reduce Cr(VI), but nickel metal will precipitate out of the bath: Ni²⁺+2e⁻===>Ni(s), E⁰=−0.25V. For these reasons, it is desirable to utilize a reducing agent that will result in either gaseous or water soluble by-products. Depending on the choice of reducing agent, the process parameters can be adjusted based on a design of experiments by varying the temperature, pH, and concentration of the reducing bath, as would be understood by one having ordinary skill in the art.

Upon removal from the reducing solution, the steel article is rinsed with deionized or tap water, for example, then dried. The rinse generally involves using a series of counter flow rinse tanks and immersing the article in each tank for about 30 seconds at room temperature. The adequacy of the rinse process may be confirmed by monitoring a final rinse tank for pH and drag out of the reducing agent. Drying of the steel article, with its trivalent chromium conversion coating, may occur at room temperature and for a sufficient period of time for the conversion coating to dry. As understood by one having ordinary skill in the art, both time and temperature are interdependent, i.e., the warmer the drying air, the shorter the drying time, which is typically verified visually.

In another embodiment, one or more optional reducing solutions for reducing hexavalent chromium, as fully discussed above, may be used during the trivalent chromate conversion coating process. For example, an additional bath including a reducing solution having a reducing agent, e.g., sodium hydrosulfite, may be provided before the first drying process, which follows the rinse after the chromate passivation treatment in the trivalent chromate conversion coating process. Accordingly, the zinc plated steel article with its trivalent chromate conversion coating, which includes hexavalent chromium, can be placed into the optional reducing solution for an interval independently determined to reduce the hexavalent chromium. In one embodiment, the steel article is immersed for 5-60 minutes at a temperature of 25° C.-90° C. As explained above, the reducing agent reacts with the hexavalent chromium to reduce it to trivalent chromium, for example.

After the indicated period, the steel article is removed and optionally rinsed in tap water then finally dried. The rinse generally involves using a series of counter flow rinse tanks and immersing the article in each tank for about 30 seconds at room temperature. As discussed fully above, drying of the steel article, with its trivalent chromium conversion coating, may occur at room temperature and for a sufficient period of time for the conversion coating to dry. Despite the optional reducing solution for reducing hexavalent chromium, it is still possible for trivalent chromium in the trivalent chromate conversion coating to interconvert, i.e., be oxidized, such as via air oxidation of residual trivalent chromium on the steel article. Accordingly, the dried steel article then follows the method as previously discussed above wherein the zinc plated steel article is then placed, or immersed, in a now second reducing solution, to remove additional hexavalent chromium from the trivalent chromate conversion coating.

With respect to coating thicknesses, for electroplated coatings, such as zinc or cadmium, a typical plating thickness ranges from a minimum of 5 microns to 25 microns. For electrogalvanized steel, the plating thickness can range from 1 micron to 7 microns. The amount of trivalent chromate conversion coating deposited, for example, on top of electroplated zinc or cadmium plated parts is not typically specified in units of thickness, but rather coating weight per unit area, which typically ranges from a minimum of about 0.2 grams per square meter to about 2.0 grams per square meter. For electrogalvanized steel, the trivalent chromate conversion coating is thinner, and would normally range from about 0.05 grams per square meter to about 0.4 grams per square meter.

For hot dip galvanized or aluminum plated steel, for example, the metal coating is generally specified in units of mass/area. These metal coatings would typically range between 15 grams per square meter to 500 grams per square meter. And similar to electrogalvanized steel, the trivalent chromate conversion coating could be expected to range from about 0.05 grams per square meter to about 0.4 grams per square meter. When trivalent chromate conversion coatings are applied on top of other metals, such as magnesium, zinc, or aluminum alloys, the chromate coating thickness may range from 0.05 grams per square meter to 2.0 grams per square meter.

Feasibility of the method for reducing hexavalent chromium in a trivalent chromate conversion coating using a reducing agent was demonstrated by immersion of Cr(VI) standards, screws, and spikes, i.e., standards, screws, and spikes with a hexavalent chromate conversion coating, in an extraction medium, which included a reducing agent. The standards, screws, and spikes were zinc-plated steel articles having a predetermined amount of hexavalent chromium coating (in ppb). To that end, hexavalent chromium was extracted using either an alkaline or deionized water extraction medium, which included sodium hydrosulfite (SHS) in a concentration of 10-20 g/L. Controls were established which excluded the presence of the reducing agent. Extractable hexavalent chromium was quantitatively reduced insofar as the amount of detectable hexavalent chromium (in ppb) remaining in the extraction medium after a specified period of time was determined.

Alkaline extraction was accomplished as follows. Samples of Cr(VI) standards and screws, as identified in the table below, were placed into an appropriate reaction vessel into which 50 ml of an alkaline solution (2 g NaOH, 3 g Na₂CO₃ per 1 L deionized water) was poured. Reaction vessels were then placed into a hot water bath (set point of 90° C.) and subjected to ultrasonic agitation (Branson 7000 Series; 1250 watt generator; 40 KHz output) for one hour.

Deionized (DI) water extraction was accomplished as follows. Samples of Cr(VI) standards and screws, as identified in the table below, were placed into an appropriate reaction vessel into which 50 ml deionized water was poured. Reaction vessels were then placed into a hot water bath (set point of 100° C.) and subjected to ultrasonic agitation (Branson 7000 Series; 1250 watt generator; 40 KHz output) for ten minutes.

Following extraction, the samples were allowed to cool to room temperature at which time the samples were removed from the solution and rinsed in deionized water (which was collected). In the event of precipitation, the solution was either centrifuged for 15 min at 2700 rpm or filtered through a 0.45 um filter. The supernatant was transferred to a beaker and a stir bar added. Nitric acid was added dropwise until a pH of 7.5±0.5 was reached. If a precipitate formed, the sample was centrifuged again at 2700 rpm for 5 min. The supernatant was transferred into a beaker to which an appropriate volume (1.0 ml) of diphenylcarbazone (DPC) solution was added. The pH was brought to 2.0±0.5 by dropwise addition of 20% sulfuric acid solution.

The contents of the beaker were then transferred to a 50 ml volumetric flask and diluted to volume. Absorbance of the Cr(III)-diphenylcarbazone complex was determined using a 10-cm path length cell and Cr(VI) concentration determined from a calibration curve (standards carried through the digestion process). In the event of color formation in the extract, absorbance at 540 nm was determined prior to neutralization and DPC addition and subsequently subtracted from the absorbance of the Cr(III)-diphenylcarbazone complex. The results are shown in the Table below.

| | [SHS], | | [Cr(VI)], |
|---|---|---|---|
| Sample | g/L | Extraction Method | ppb |
| 500 ppb chrome | 0 | Alkaline Media (90 C./60 min) | 437.4 |
| Screw | | | |
| 500 ppb chrome | 10 | Alkaline Media (90 C./60 min) | 63.2 |
| Screw | | | |
| 500 ppb chrome | 20 | Alkaline Media (90 C./60 min) | ND* |
| Screw | | | |
| 500 ppb chrome | 10 | Alkaline Media (90 C./60 min) | ND* |
| spike | | | |
| 500 ppb chrome | 0 | DI Water (100 C./10 min) | 13.9 |
| Screw | | | |
| 500 ppb chrome | 10 | DI Water (100 C./10 min) | ND* |
| Screw | | | |
| 500 ppb chrome | 10 | DI Water (100 C./10 min) | ND* |
| spike | | | |
| 150 ppb chrome | 0 | Alkaline Media (90 C./60 min) | 151.4 |
| std | | | |
| 300 ppb chrome | 0 | Alkaline Media (90 C./60 min) | 300.4 |
| std | | | |

*ND = none detected below the detection limit of 2.0 ppb

The test results in the table show that the hexavalent chromium was reduced in those samples exposed to extraction medium having sodium hydrosulfite as compared to those samples exposed to extraction medium free from sodium hydrosulfite. In addition, the resulting hexavalent chromium concentration decreased as the concentration of sodium hydrosulfite increased in the extraction medium.

While the present invention has been illustrated by the description of one or more embodiments thereof, and while the embodiments have been described in considerable detail, they are not intended to restrict or in any way limit the scope of the appended claims to such detail. Additional advantages and modifications will readily appear to those skilled in the art. The invention in its broader aspects is therefore not limited to the specific details, representative product and/or method and examples shown and described. Accordingly, departures may be made from such details without departing from the scope of the general inventive concept.

What is claimed is:

1. A method for reducing hexavalent chromium in a trivalent chromate conversion coating comprising:
placing in a reducing solution a metal article having a trivalent chromate conversion coating, the trivalent chromate conversion coating including hexavalent chromium and the reducing solution including a reducing agent, wherein the reducing agent reduces the hexavalent chromium.

2. The method of claim 1 wherein the reducing agent reduces the hexavalent chromium to trivalent chromium.

3. The method of claim 1 wherein the reducing agent reduces the hexavalent chromium so that trace to no hexavalent chromium remains in the trivalent chromate conversion coating.

4. The method of claim 1 wherein the metal article is a zinc plated steel article.

5. The method of claim 1 wherein the reducing agent is sodium hydrosulfite.

6. The method of claim 1 wherein the reducing solution includes about 5 g/L to about 50 g/L of reducing agent.

7. The method of claim 1 further comprising removing the metal article from the reducing solution, rinsing the metal article, and drying the metal article.

8. The method of claim 1 further comprising, prior to placing in the reducing solution the metal article having the trivalent chromate conversion coating, applying the trivalent chromate conversion coating to the metal article, rinsing the metal article, and drying the metal article.

9. The method of claim 1 wherein the reducing agent reduces the hexavalent chromium so that less than 1000 ppb of hexavalent chromium remains in the trivalent chromate conversion coating.

10. A metal article having a trivalent chromate conversion coating treated in accordance with the process of claim 1.

11. A method for reducing hexavalent chromium in a trivalent chromate conversion coating comprising:
immersing a metal article in a trivalent chromium solution to apply a trivalent chromate conversion coating to the metal article;
removing the metal article from the trivalent chromium solution, the metal article including the trivalent chromate conversion coating;
placing in a reducing solution the metal article having the trivalent chromate conversion coating, the trivalent chromate conversion coating including hexavalent chromium and the reducing solution including a reducing agent; and
reducing the hexavalent chromium in the reducing solution to trivalent chromium by reacting the hexavalent chromium with the reducing agent.

12. The method of claim 11 wherein reducing the hexavalent chromium in the reducing solution comprises reducing the hexavalent chromium in the reducing solution to trivalent chromium by reacting the hexavalent chromium with the reducing agent so that trace to no hexavalent chromium remains in the trivalent chromate conversion coating.

13. The method of claim 11 wherein the metal article is a zinc plated steel article.

14. The method of claim 11 wherein the reducing agent is sodium hydrosulfite.

15. The method of claim 11 wherein the reducing solution includes about 5 g/L to about 50 g/L of reducing agent.

16. The method of claim 11 further comprising, after reducing the hexavalent chromium in the reducing solution to trivalent chromium by reacting the hexavalent chromium with the reducing agent, removing the metal article from the reducing solution, rinsing the metal article, and drying the metal article.

17. The method of claim 11 further comprising, prior to placing in the reducing solution the metal article having the trivalent chromate conversion coating including the hexavalent chromium and after removing the metal article from the trivalent chromium solution, rinsing the metal article, and drying the metal article.

18. The method of claim 11 wherein reducing the hexavalent chromium in the reducing solution comprises reducing the hexavalent chromium in the reducing solution to trivalent chromium by reacting the hexavalent chromium with the reducing agent so that less than 1000 ppb of hexavalent chromium remains in the trivalent chromate conversion coating.

19. A method for reducing hexavalent chromium in a trivalent chromate conversion coating comprising:
applying a trivalent chromate conversion coating to a metal article;
placing in a first reducing solution the metal article having the trivalent chromate conversion coating, the trivalent chromate conversion coating including hexavalent chromium and the first reducing solution including a first reducing agent, wherein the first reducing agent reduces the hexavalent chromium;
drying the metal article; and
placing in a second reducing solution the metal article having the trivalent chromate conversion coating which includes additional hexavalent chromium, the second reducing solution including a second reducing agent, wherein the second reducing agent reduces the additional hexavalent chromium.

20. The method of claim 19 wherein the first reducing agent reduces the hexavalent chromium to trivalent chromium and the second reducing agent reduces the additional hexavalent chromium to trivalent chromium.

21. The method of claim 19 wherein the metal article is a zinc plated steel article.

22. The method of claim 19 wherein at least one of the first and second reducing agents is sodium hydrosulfite.

23. The method of claim 19 wherein the first and second reducing solutions include about 5 g/L to about 50 g/L of first and second reducing agent, respectively.

24. The method of claim 19 further comprising, after placing in a second reducing solution the metal article having the trivalent chromate conversion coating which includes additional hexavalent chromium, removing the metal article from the second reducing solution, rinsing the metal article, and drying the metal article.
